(19) United States
(12) Patent Application Publication
(10) Pub. No.: US 2007/0057089 A1
(43) Pub. Date: Mar. 15, 2007

(54) Image generating process

(76) Inventor: Gerd Alwin Schröter, Siegen (DE)

Correspondence Address: BIRCH STEWART KOLASCH & BIRCH, PO BOX 747, FALLS CHURCH, VA, 22040-0747, US

(21) Appl. No.: 10/552,446

(22) PCT Filed: Apr. 7, 2004
(86) PCT No.: PCT/IB04/01436

§ 371 Date: Aug. 16, 2006

(30) Foreign Application Priority Data
Apr. 8, 2003 (EP) 03405237.3

(51) Int. Cl. B64D 1/18

(52) U.S. Cl. 239/171

(57) ABSTRACT

In a method for generating an image on a land surface by means of an applicator (11), the applicator (11) is first moved on a first place on the land surface and the position of the applicator (11) is determined. Depending on the thus determined position, a marking substance is then applied to the land surface. Finally, the applicator (11) is moved to another place on the land surface. A device for generating an image on a land surface comprises locating means (8.1, 8.2, 9) for locating a position of the device, application means (11) for applying a marking substance to the land surface and control means (9) for automatically controlling the application means (11) depending on the thus determined position.

### TECHNICAL FIELD

The invention relates to a method in order to produce an image on a land surface by means of an emission apparatus, and to an apparatus for production of an image on a land surface.

### PRIOR ART

It has been known for a long time for strips in sports stadiums which, for example, surround a field of play for football or ice hockey, to be provided with inscriptions, logos and images, predominantly of an advertising nature. This advertising often reaches not only the public who are attending the game but, by means of television transmissions, a far greater group of people.

In the case of skiing and other winter sports events, which are likewise often broadcast by television, printable strips can be applied only to a restricted extent. Guard nets at the edge of the pistes are, for example, generally designed for technical reasons such that printing is not possible in a manner which would allow advertising messages to be recognized from a relatively long distance. In the field of winter sports, advertising can therefore often be disseminated only by means of conventional notices that are erected. However, these often lead to impediments and can generally be installed only at points where they can scarcely be seen. Another option is to lay out printed hoarding over the ground. However, these can likewise be seen only with difficulty and can be applied only at points which are away from the piste and the viewer area. Furthermore, large printed hoardings are expensive and require complex anchorages against the influence of wind.

### DESCRIPTION OF THE INVENTION

One object of the invention is to provide a method which is associated with the technical field mentioned initially and improves the installation and dissemination of advertising.

The object is achieved as defined by the features of claim 1. According to the invention, the image is produced on the land surface by means of the emission apparatus by first of all moving the emission apparatus to a first point on the surface and then carrying out a circling process a plurality of times, comprising the following steps:
a) determination of a position of the emission apparatus;
b) emission of a marking substance onto the land surface, as a function of the determined position;
c) movement of the emission apparatus to a further point on the land surface.

There are typically large snowy areas in winter sports regions. All of these areas can be used as an advertising surface by means of the method according to the invention. In this case, there is no impediment by users of the snowy area, for example skiers, or those watching a winter sports event. The image can be produced at low cost and over an extremely large area, and is resistant to the influence of the wind. There is no need to remove an image once it has been produced: for as long as the advertising message is intended to remain in existence, the method according to the invention must be carried out regularly in order to refresh the image, for example once a week. Depending on the weather influences, the interval can be adapted. When the refreshing is no longer carried out, the image disappears after a certain amount of time as a result of the weather influences, on its own.

The use of the method is not restricted to the production of advertising messages. It can likewise be used to produce sponsoring details or location details for the orientation of the winter sportsmen or tourists. The method according to the invention can also be used to produce direction details, warning notices and information notices on skiing pistes, cross-country skiing runs, winter walking routes etc.

The method according to the invention is also suitable for the production of images on other land surfaces such as roads, fields or sandy areas.

The position of the emission apparatus which has been determined is preferably stored in the circling process. The marking substance is then emitted as a function of the already stored positions. This makes it possible to move the emission apparatus a plurality of times to the same point on the land surface without multiple emission of the marking substance. In fact, by virtue of the storage of all of the already covered regions of the land surface, it is known which parts of the image have already been produced. This prevents marking substance from being consumed unnecessarily, and also prevents the substance from being distributed nonuniformly on the surface. The operator of the emission apparatus can thus move the apparatus as required over the surface, and the only condition for a complete image is that each area of the surface must have been covered at least once by the emission apparatus.

Alternatively, it is possible not to store the position data on the already covered regions. In this case, it is advantageous to have the capability for the emission apparatus to be switched on and off manually by the operator. The operator will then switch the emission apparatus off whenever he is once again passing over an already covered region. The emission apparatus is, furthermore, in this case advantageously moved regularly, for example along parallel straight paths, over the land surface, so that each part of the surface is as far as possible passed over once, and only once.

The instantaneous speed of the emission apparatus with respect to the land surface is advantageously determined, and the emission power with which the marking substance is emitted is matched to the instantaneous speed. This is because, if the emission apparatus is moved at high speed over the surface, this results in less marking substance density than when moving over at a lower speed, for a constant emission rate. The adaptation of the quantity of substance emitted (or the emission rate) leads to uniform marking with a constant substance density.

Alternatively, the speed at which the emission apparatus is moved over the surface can be fixed, for example by means of a speed control device for a vehicle to which the emission apparatus is fitted.

The image is preferably produced by distorting image data as a function of angles between the land surface and a predetermined observation direction. If an image which is arranged on a surface is viewed from a certain angle, this results in a certain amount of distortion, depending on the angle. In most cases, however, certain preferred observation positions are predetermined, and thus certain preferred observation directions. Appropriate distortion of the image to be sprayed results in a distorted image for observers who are located approximately along the predetermined observation direction, that is to say an image which appears to be upright, without any shortening in any direction. On the one hand, this makes it easier to read and/or identify the image, while on the other hand an image such as this which is apparently at an angle to the surface is more conspicuous than one which is obviously flat on the surface. Furthermore, the distortion can be used to produce certain three-dimensional effects.

Preferred observation directions result from preferred locations of observers, for example local areas, in winter sports regions, for example including cable cars or gondola cars or other transport means, skiing pistes, inns etc. In this respect, however, the locations of television cameras (for example for sports transmissions), webcams, weather cameras etc. are also of particular interest for advertising.

If the images are intended to be highly visible from directions which differ greatly from one another, or if the observers are looking at the surface virtually at right angles, it is preferable not to provide any distortion.

The position is advantageously determined by means of a navigation system, in particular GPS or GLONASS, preferably differential GPS (dGPS). As soon as these are available, it will also be possible to use future systems, such as Galileo. Systems such as these allow the position to be found quickly, accurately and absolutely, and cost little. They require no local installations to define a local reference. Whilst the position data for the image to be produced has been determined, the method can be carried out as often as desired at the same point, and the marking substance will always be emitted at the same points. This makes it easier to refresh an image which has already been produced at an earlier stage, or to produce the same or other images for the first time on the same land surface.

The application thus extends, inter alia, to the marking of piste boundaries as well. In comparison to the conventional posts, boundaries which have been produced by means of a method according to the invention and are in the form of continuous lines have the advantage that they indicate the edge of the piste to piste users everywhere, and not only at certain points which are marked by posts. The risk of accidentally leaving the marked piste in fog is avoided. The piste boundary can reliably be regularly renewed with the aid of the navigation system. Optimum confidence for the marking of the piste edge is offered by a combination of the conventional posts and the continuously marked line.

Alternatively, it is possible to use other navigation systems that are available at the point of use. Orientation with respect to locally arranged reference points, for example infrared, radio or microwave transmitters, is also compatible with position finding.

In one preferred variant of the method, the image is produced on a surface composed of snow. In this case, color, in particular liquid color, is emitted onto the surface composed of snow. Liquid food color is advantageously used as the color. Liquid color binds best with the snow and, from the technical point of view, can be processed most easily. Food color is highly suitable for coloring snow surfaces and, furthermore, has the advantage that there is no risk to the health of people or animals, or of damage to plants.

Alternatively, other types of liquid colorants as well as solid colors (pigment particles) can be used.

In another preferred method variant, the image is produced on a road surface, with a color which can be removed, in particular an alcohol-based color, being emitted onto the road surface. The road surface may, in particular, have an asphalt, tar or concrete surface. In addition to the capability to remove it, care must be taken when choosing the color that is used to ensure that it does not lead to an increased risk of accidents because, for example, the surface of the printed road area has been changed in such a way that the adhesion is greatly reduced. Even in the event of rain, the adhesion on the printed surface should not be significantly poorer than on the remaining area of the road. An alcohol-based color offers the advantages that it resists rain and other environmental influences for a certain time, but can nevertheless be removed easily and in an environmentally-friendly manner, again. In comparison to colors which form a continuous layer on the asphalt, a color such as this furthermore leads to less decrease in the surface adhesion. The surface adhesion can even be improved by suitable additives, such as fine-grain rubber granulates.

The color for production of an image on a road surface advantageously contains reflective constituents. These make the image more visible, even in poor lighting conditions.

In a further method variant, the image is produced on a surface composed of sand, wherein color is emitted onto the surface. This is particularly useful in the case of sporting events such has rallys, in which the application of advertising has in the past resulted in similar problems to those which have been described above for winter sports events. The image on the surface composed of sand will be automatically erased after a certain amount of time by the weather, in particular by the wind. When choosing the color, care should be taken to ensure that it is environmentally friendly; for example, it is possible to use nontoxic solid color pigments or else very fine sand grains with a different color from the background.

The color is preferably emitted, that is to say sprayed, by means of at least one nozzle onto the land surface. In comparison to other printing techniques, this makes it possible to largely avoid moving parts, thus keeping the maintenance effort for the emission apparatus low. The emission apparatus furthermore need not directly touch the surface to be printed on, so that it is not contaminated. The spraying-on process furthermore leads to a uniform application of color, even on uneven surfaces.

The color can also be emitted onto the land surface by means of a printing roller. The printing roller is coated with color, which is then transferred from the roller onto the surface to be printed on. This results in point-precision printing. Furthermore, the transfer of the color to the surface is controlled, and external influences, for example caused by the wind, are minimized.

In a further variant of the method according to the invention, the image is produced on a fertile surface, wherein the marking substance comprises plant seeds which are sowed onto the fertile surface by the emission apparatus. In this case, it is possible to selectively sow plants which bloom with different colors but at the same time, thus resulting in a multicolor image during the time in which the plants are in bloom. Plants with different colored leaves can also be used to produce an image, so that the image can be produced for a longer time or—with certain evergreen plants—virtually permanently. The image can also be produced by emitting plant seeds only in specific areas of the image which are to be “printed on”. Finally, it is even possible to use plants which bloom at different times to produce images which change over time, by a first group of plants displaying a first image during their blooming time, while a second group of plant types display a second, different image during their blooming time.

The emission apparatus is preferably arranged on a vehicle, wherein the emission apparatus is moved over the land surface with the vehicle. A motorized vehicle can be used to cover large areas in a short time, so that large-area images can be produced which are easily visible all the way round.

Alternatively, an appropriately compact emission apparatus can be arranged on a slide, a carriage or a supporting frame which can be moved manually over the surface. The apparatus can also be moved by a gantry crane over the surface to be printed on. In order to produce very large-area images or images in areas where access is difficult, the apparatus according to the invention can also be attached to a helicopter, advantageously via a cable to a winch, so that the wind produced by the rotor does not interfere with the emission of the marking substance.

The vehicle is preferably moved over the land surface automatically on the basis of the positions that have been found. The vehicle is thus self-controlling. This allows optimum movement efficiency to be achieved by the vehicle being driven precisely to where it is still necessary to emit the marking substance, that is to say the area to be printed on is moved over in a correspondingly short time, along a path which is as short as possible. While the movement is being carried out, an operator may be located in the vehicle for monitoring purposes, although the vehicle can also produce the image without being manned.

Alternatively, the vehicle is driven over the surface by the operator in the normal manner.

An apparatus for production of an image on a land surface has position-finding means for determination of a position of the apparatus, emission means for emission of a marking substance onto the land surface, and control means for automatically controlling the emission means as a function of the determined position.

The position-finding means preferably comprise a receiver for a navigation system, in particular for GPS or GLONASS, preferably for differential GPS (dGPS). Receivers such as these are easily available, are essentially maintenance-free and cost little. Particularly when differential GPS is used, they offer very high accuracy in the centimetric range, which allows high resolution of the image to be sprayed on.

Particularly preferably, the position-finding means comprise at least two receivers, which are arranged at a distance from one another, for the navigation system. In addition to the position finding, this also makes it possible to determine the orientation of the apparatus without any need for information about previous positions or about speeds of travel. This allows the control of the emission means to be further improved.

The control means preferably comprise storage means for storage of specific positions and means for automatically controlling the emission means as a function of the stored positions.

The apparatus advantageously also has means for determination of an instantaneous speed of the apparatus with respect to the land surface, wherein the control means comprise means for controlling the emission means as a function of the determined instantaneous speed. The means for determination of the instantaneous speed can interact with the receiver for the navigation system or with speed measurement devices which are already provided on a vehicle, or else may be independent thereof. The means for controlling the emission means may, for example, comprise controllable valves or controllable pumps.

The control means preferably comprise means for distortion of image data as a function of angles between the land surface and a predetermined observation direction.

Alternatively, the image data may be processed and distorted in advance, for example on a personal computer (PC). The processed data is fed to the control means in a manner known per se, for example by means of data storage media such as data cards, CD-ROMs or DVDs, by wire via a data cable, or without the use of wires by means of GSM, UMTS, WLAN, etc.

The emission means advantageously comprise a row of nozzles, which are arranged alongside one another and fixed with respect to the apparatus, for spraying color onto the land surface. Nozzles which are arranged in a fixed form offer the advantage that there is no need for complex mechanisms, which are susceptible to faults, for movement of the nozzles; in contrast to nozzles which are moved during the printing process, for example in the form of an inkjet printer.

The row of nozzles can be used to produce an image strip simultaneously, whose width corresponds essentially to the width of the emission apparatus.

In one advantageous embodiment of the invention, the emission means are connected by supply lines to tanks for a plurality of primary colors, wherein the emission means comprise a mixing apparatus, which is arranged upstream of the nozzles, for mixing the primary color as a function of a desired intended color. Since the color is in fact mixed before being sprayed on, the number of nozzles can be reduced. There is no need to split the image into a raster pattern, because printing is carried out directly with the desired color. The control of the image production and of the spraying process is correspondingly simplified.

In another advantageous embodiment of the invention, the emission means for spraying each of a plurality of primary colors comprise a row of nozzles which are arranged fixed alongside one another, with the rows being arranged one behind the other. In consequence, there is no need to carry out any mixing process in the apparatus, and its design can be correspondingly simpler. In order nevertheless to allow mixed colors in the image that is produced, the colors are either chosen such that they can be sprayed successively onto the same point, or such that they mix themselves before drying on the surface that is to be marked, or the image pattern is split into a raster pattern in a manner known per se for four-color printing. The arrangement of the nozzle rows one behind the other allows good resolution in the lateral direction with little space being required. In the case of raster printing, a certain offset between the nozzle rows that are arranged one behind the other can be advantageous.

The apparatus according to the invention can preferably be fitted to a vehicle, in particular a snowmobile, a road vehicle or a cross-country vehicle, or to an agricultural vehicle. The apparatus is moved over the land surface with the vehicle.

The apparatus can advantageously be fitted interchangeably to a piste groomer, with the emission apparatus comprising a printing device with a lateral extent which corresponds at least approximately to the lateral extent of the piste groomer. The printing device can be fitted to an existing rear fitting on the piste groomer. Piste groomers are normally available in winter sports regions so that there is no need to procure any additional, expensive vehicle to carry out the method according to the invention. The operation of vehicles such as these is also entrusted to the local authorities. Piste groomers are wide so that large images can also be produced in a short time with one printing device which essentially covers at least their width. It is normal to retrofit piste groomers with special tools, for example rollers, blades, etc. Various rear fittings are thus available, inter alia, in particular track cutting machines or snow clearing machines, trailer units, track machines or smoothers. The fact that the printing device can be fitted to an already existing rear fitting such as this offers the advantage that the already existing attachment to the piste groomer can still be used, and need not be provided once again. The rear fitting can also prepare the snow surface so as to produce a good printing base.

In particular, as an alternative, smaller images can also be produced on snow surfaces by snowmobiles. These are also normally available in winter sports regions. In comparison to a piste groomer, they are also more flexible in use and, particularly in the case of relatively small images, can be used more easily, better and quicker.

The apparatus can also be designed such that it does not interact with an existing rear fitting. In this case, it advantageously has means for fitting the apparatus to a piste groomer, which interact with normal attachment devices for special tools (such as rollers, blades etc.). The means for fitting are thus preferably matched to these attachment devices, so that the apparatus can be retrofitted easily. Snowmobiles often also have usable attachment means, such as trailer couplings.

Alternatively, the apparatus according to the invention has its own means by which it can be moved over the snow surface, for example rolls, rollers or skids.

Depending on the size, it may have an engine or motor for assistance. The apparatus can optionally be arranged on a carrying apparatus, for example in the form of a rucksack.

The two receivers for the navigation system are preferably arranged close to the two lateral ends of the printing device, which is fitted to the rear of the piste groomer. This results in a long distance between the receivers, which allows accurate angle measurements and thus precise image production.

For self-propelled operation, the apparatus advantageously comprises a drive controller which is coupled to the position means and is designed in such a manner that it can control the vehicle automatically, so that the apparatus is moved over the land surface automatically. The drive controller can be mechanically coupled to the vehicle control, for example via hydraulics or pneumatics; alternatively, electrical or electronic coupling is also possible.

Further advantageous embodiments and feature combinations of the invention will become evident from the following detailed description and from the totality of the patent claims.

### BRIEF DESCRIPTION OF THE DRAWINGS

In the drawings, which will be used to explain the exemplary embodiment:

FIG. 1 shows a schematic illustration of a piste groomer and an apparatus according to the invention, viewed obliquely:

FIG. 2 shows a schematic illustration of the piste groomer, viewed from the side;

FIG. 3 shows a schematic illustration of the piste groomer, seen from above;

FIG. 4 shows a schematic illustration of a first embodiment of a spraying apparatus according to the invention, viewed from the side;

FIG. 5 shows a schematic illustration of a second embodiment of a spraying apparatus according to the invention, viewed from the side;

FIGS. 6A, B show a first arrangement of spraying nozzles for a spraying apparatus according to the invention;

FIGS. 7A, B show a second arrangement of spraying nozzles for a spraying apparatus according to the invention;

FIGS. 8A, B show a third arrangement of spraying nozzles for a spraying apparatus according to the invention;

FIG. 9 shows a schematic illustration of the circuit of an apparatus according to the invention;

FIGS. 10A-C show a schematic illustration of the method according to the invention;

FIG. 11A shows a schematic illustration of an inscription, produced using the method according to the invention, seen from a predetermined observation position; and

FIG. 11B shows a schematic illustration of the inscription, sprayed onto a snow surface.

Fundamentally, identical parts are provided with the same reference symbols in the figures.

### APPROACHES TO IMPLEMENTATION OF THE INVENTION

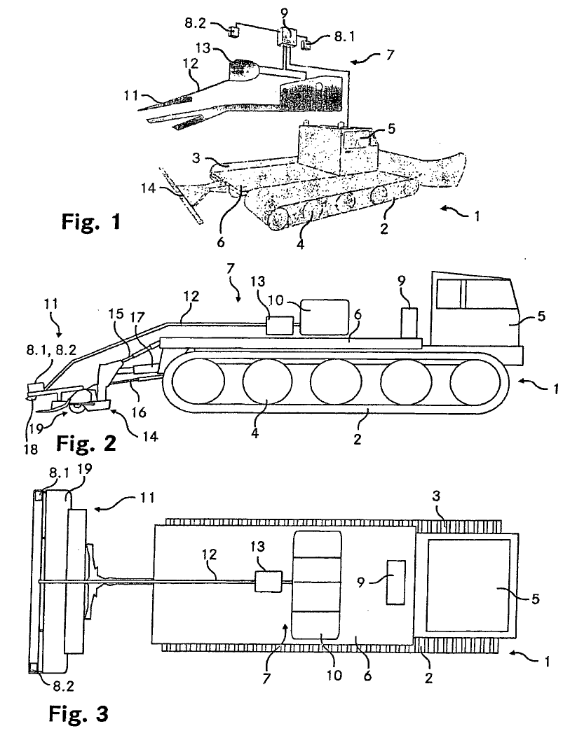

FIGS. 1 to 3 show schematic illustrations of a piste groomer having an apparatus according to the invention, viewed obliquely, from the side and from above. The piste groomer 1 is known per se and, on its underneath, has a groomer 2 or 3 on each side, which in each case runs over a plurality of rollers 4. A driver's cab 5 is arranged at the front end of the piste groomer 1, and all of the control elements for the piste groomer 1 are arranged in it. On its upper surface, the piste groomer 1 has a load surface 6. Depending on the use of the piste groomer 1, this load surface 6 may be fitted with specific attachments such as cabs, rollers that can be folded up, etc.

The apparatus 7 according to the invention for production of an image on a snow surface comprises two GPS receivers 8.1 and 8.2, a controller 9, a color tank 10, a spraying apparatus 11, a line 12 and a pump 13. The two GPS receivers 8.1, 8.2 are arranged at mutually opposite lateral ends on the spraying apparatus 11. The controller 9 is arranged at the front end of the load surface 6 and essentially comprises a conventional PC (Personal Computer) which is protected by a housing against cold, moisture and vibrations. The power supply for the controller 9 is provided from the vehicle battery. The color tank 10 is fitted centrally on the load surface and comprises four individual tanks for the colors black, yellow, cyan and magenta. The line 12, which correspondingly has four separate channels, leads from the color tank 10 first of all to the pump 13 and from there on to the spraying apparatus 11.

The spraying apparatus 11 is mounted on a rear fitting 14 on the piste groomer 1. The rear fitting 14 may be a generally conventional appliance such as a track cutting machine or snow clearing machine, a trailer unit, a track machine or a smoother. Rear fittings such as these are normally coupled to the piste groomer 1 via a plurality of holding and guide rods 15, 16. A rotary movement can be transmitted via a rotating shaft 17 and can be used, for example, to drive cutting disks. The spraying apparatus 11 is mounted on the rear fitting 14 such that the color which is passed out of the color tank 10 can be emitted onto the snow surface by means of nozzles 18 behind the equipment 19 of the rear fitting 14. The rear fitting 14 can be selected and prepared such that it prepares the snow surface for the spray printing.

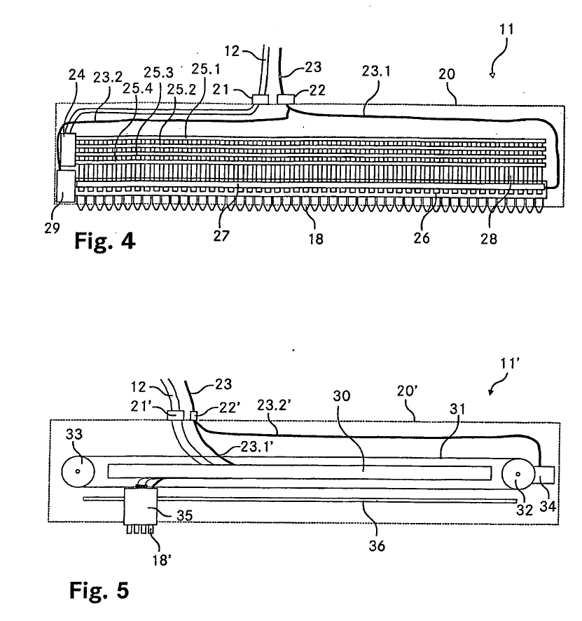

FIG. 4 shows a schematic illustration of a first embodiment of a spraying apparatus 11 according to the invention, viewed from the side. The spraying apparatus 11 is surrounded by a housing 20 and, on its upper face, has an input 21 for the line 12 and an input 22 for a control line 23, via which the spraying apparatus 11 is controlled. At the input 22, the control line 16 branches in the interior of the housing 20 into a valve control line 23.1 and a drive control line 23.2. The line 12 for the color continues within the housing to a color distributor 24, where the four individual line elements of the line 12 for the four primary colors are connected to in each case one of four color feeder tubes 25.1 . . . 25.4. The color feeder tubes 25.1 . . . 25.4 extend approximately over the entire width of the spraying apparatus 11, and are all arranged parallel to the main axis of the spraying apparatus 11.

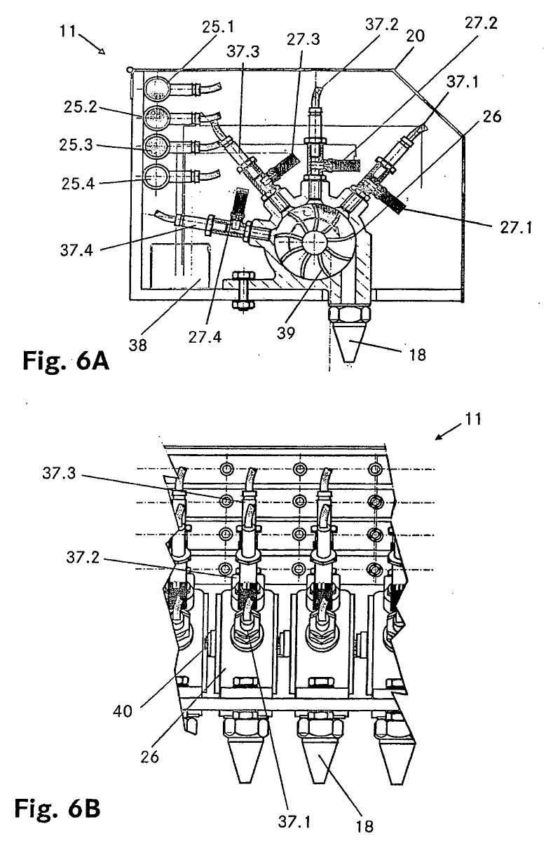

A row of nozzles 18 is arranged at the rear end of the spraying apparatus 11. Each of the nozzles has an associated swirling chamber 26 on its rear face, which has connections 28, provided with valves 27, to each of the four color feeder tubes 25.1 . . . 25.4. An impeller wheel is provided within each of the swirling chambers 26, and all of the impeller wheels can be operated jointly by a drive 29. Dog clutches are arranged between the individual swirling chambers 26 for this purpose. The nozzles 18 are illustrated in FIGS. 6A, B, and will be described in detail further below.

The drive 29 for the impeller wheels in the swirling chambers 26 is controlled by the drive control line 23.2, and the valves 27 in the nozzles 18 are controlled via the valve control line 23.1. The power is supplied to the drive 29 either likewise via the drive control line 23.2 or else mechanically via the rotating shaft 17 from the piste groomer 1.

FIG. 5 shows a schematic illustration of a second spraying apparatus 11′ according to the invention, seen from the side. The spraying apparatus is surrounded by a housing 20′ and, on its upper face, has an input 21′ for the line 12 as well as an input 22′ for the control line 23, by means of which the spraying apparatus 11′ is controlled. The control line 23 branches at the input 22′, in the interior of the housing 20′, into a spraying head control line 23.1′ and a drive control line 23.2′.

The line 12 for the color as well as the spraying head control line 23.1′ are passed to a channel 30 in the interior of the housing 20, and this channel 30 is open at the top. A toothed belt 31 is arranged in front of the channel 30 and is passed over two rollers 32, 33. The roller 32 is driven by a stepping motor 34 which on the one hand is controlled and on the other hand is supplied with power from the drive control line 23.2′. The spraying head 35, which is attached to the toothed belt 31, can be moved backwards and forwards along the spraying apparatus 11′ by means of the stepping motor 34 and the toothed belt 31. The length of the line 12 and of the spraying head control line 23.1′, which are routed in the channel 30 and emerge through an aperture along the lower face of the channel 30, is chosen such that the movement of the spraying head 35 is not impeded.

On its lower face, the spraying head 35 has four rows of nozzles 18′, one each for the colors black, yellow, cyan and magenta, and is mounted on a longitudinal rail 36. The spraying apparatus 11 thus operates essentially like a conventional inkjet printer, but is about 5 to 20 times larger.

FIGS. 6A, B show a first arrangement of spraying nozzles for the spraying apparatus according to the invention. FIG. 6A shows a cross section transversely with respect to the main extent of the spraying apparatus 11 and FIG. 6B shows a plan view of a detail of the spraying apparatus 11. So-called airless nozzles are used in this first arrangement, so that there is no need for any compressed-air source. The arrangement of the nozzles in the housing 20 corresponds to that which has already been indicated roughly in FIG. 4. As already mentioned, the color is supplied via four color feeder tubes 25.1 . . . 25.4 which are arranged parallel one above the other, for the colors black, magenta, cyan and yellow. Four feeders 37.1 . . . 37.4 are connected to these tubes via plug connections. Induction valves 27.1 . . . 27.4 are provided within the feeders 37.1 . . . 37.4. These are operated by a controller 38, which is in turn monitored by the valve control line.

Behind the valves, the feeders 37.1 . . . 37.4 open into the swirling chamber 26, in which an impeller wheel 39 is arranged such that it can rotate. The impeller wheels in the swirling chambers 26, which are arranged alongside one another, are all driven by the same drive via an endless dog clutch 40. The color proportions are governed by the operation of the induction valves 27.1 . . . 27.4. The amounts of color that are released are mixed with one another within the swirling chamber 26. The mixed color is then sprayed through a nozzle 18 that is connected to the swirling chamber 26. The nozzles 18 are designed in such a way that they produce a color spot (or a color strip while the spraying apparatus 11 is being moved) of a specific geometric size on the surface to be printed on. The nozzles 18 may be adjustable in order, for example, to make it possible to take account of changes in the operating height of the spraying apparatus 11. The nozzle heads of the nozzles 18 are easily replaceable. Dirty or defective nozzle heads can thus easily be replaced, or the nozzles are matched to different operating parameters by using new nozzle heads, matched to the new task.

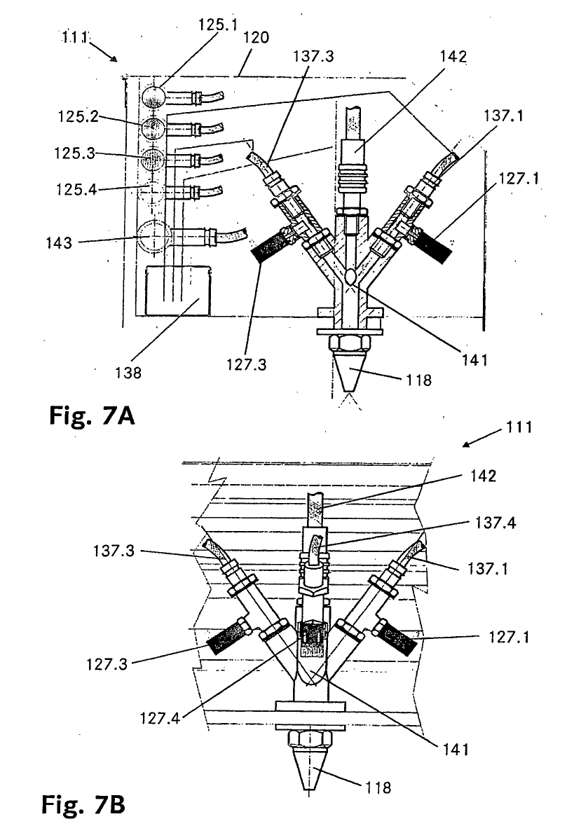

FIGS. 7A, B show a second arrangement of spraying nozzles for a spraying apparatus according to the invention. FIG. 7A shows a cross section transversely with respect to the main extent of the spraying apparatus 111, and FIG. 7B shows a plan view of a detail of the spraying apparatus 111. This second arrangement uses compressed-air nozzles. The color is once again supplied via four color feeder tubes 125.1 . . . 125.4, which are arranged parallel one above the other, for the colors black, magenta, cyan and yellow, which are accommodated in the housing 120 of the spraying apparatus 111. Four feeders 137.1 . . . 137.4 are coupled to these tubes via plug connections, and induction valves 127.1 . . . 127.4 are provided within the feeders 137.1 . . . 137.4 and are operated by a controller 138, which is once again monitored via the valve control line.

Behind the valves, the feeders 137.1 . . . 137.4 open into a common atomizer chamber 141. A feeder 142 for compressed air also opens into this chamber. This feeder 142 is connected via a plug connection to a compressed-air feeder tube 143, which provides compressed air for all the nozzles 118. The compressed air is supplied by the controller 138 as required, picks up the color particles that have been released from the individual induction valves 127.1 . . . 127.4 in the atomizer chamber 141, and mixes them. The mixed color is then sprayed through one nozzle 118. The statements that have been made above for the nozzle 18 of the spraying apparatus 11 also apply to the nozzle head of the nozzle 118.

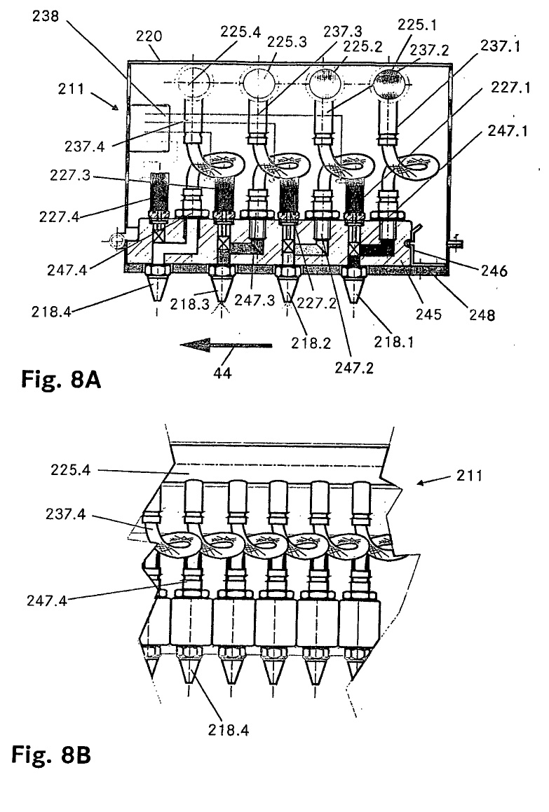

FIGS. 8A, B show a third arrangement of spraying nozzles for a spraying apparatus according to the invention. FIG. 8A shows a cross section transversely with respect to the main extent of the spraying apparatus 211, and FIG. 8B shows a plan view of a detail of the spraying apparatus 211. In this third arrangement, separate nozzles are used for the four primary colors. The colors are once again supplied via four color feeder tubes 225.1 . . . 225.4, which are arranged parallel, for the colors black, magenta, cyan and yellow. In contrast to the other illustrated spraying apparatuses, the color feeder tubes 225.1 . . . 225.4 in this embodiment variant are arranged one behind the other on the same horizontal plane, with the color feeder tube 225.4 for the yellow color being arranged in the foremost position in the direction of travel 44, and the color feeder tube 225.1 for the black color being arranged in the rearmost position in the direction of travel 44. A total of four rows of nozzles, which are arranged one behind the other, is thus formed. Four feeders 237.1 . . . 237.4 are coupled to the color feeder tubes 225.1 . . . 225.4 via plug connections.

A module 245 is held firmly on the lower face of the housing 220 by means of a clip connection 246. The module has four nozzles 218.1 . . . 218.4 for the four primary colors, with each nozzle being connected to a plug connection 247.1 . . . 247.4 to which one of the feeders 237.1 . . . 237.4 is coupled. An induction valve 227.1 . . . 227.4 is likewise arranged on the module 245, between each plug connection 247.1 . . . 247.4 and the corresponding nozzle 218.1 . . . 218.4.

The color is provided at a specific pressure in the color feeder tubes 225.1 . . . 225.4 and is thus sprayed through the nozzles 218.1 . . . 218.4 as soon as the respective induction valve 227.1 . . . 227.4 is opened. Because there is no need for any mixing process to take place in the spraying apparatus 211, the pressure that is provided is adequate for the spraying process. The amount of color is governed by the extent to which the induction valves 227.1 . . . 227.4 are opened. The colors are sprayed successively onto the surface to be printed on, with the induction valves 227.1 . . . 227.4 being controlled in such a way that the time offset between the individual valves is taken into account, that is to say the second induction valve 227.3 for cyan is, for example, driven somewhat delayed with respect to the foremost induction valve 227.4 for the yellow color, depending on the speed of travel of the spraying apparatus 211.

The module 245 can easily be replaced by first of all unfolding a protecting shroud 248 which forms the lower closure for the housing 220. The plug connections 247.1 . . . 247.4 between the module and the feeders 237.1 . . . 237.4 are then released, and the plug connector for connection of the induction valves 227.1 . . . 227.4 to the controller 238 is disconnected. The module 245, which contains the nozzles 218.1 . . . 218.4 and control valves for the four primary colors, can now be removed and replaced.

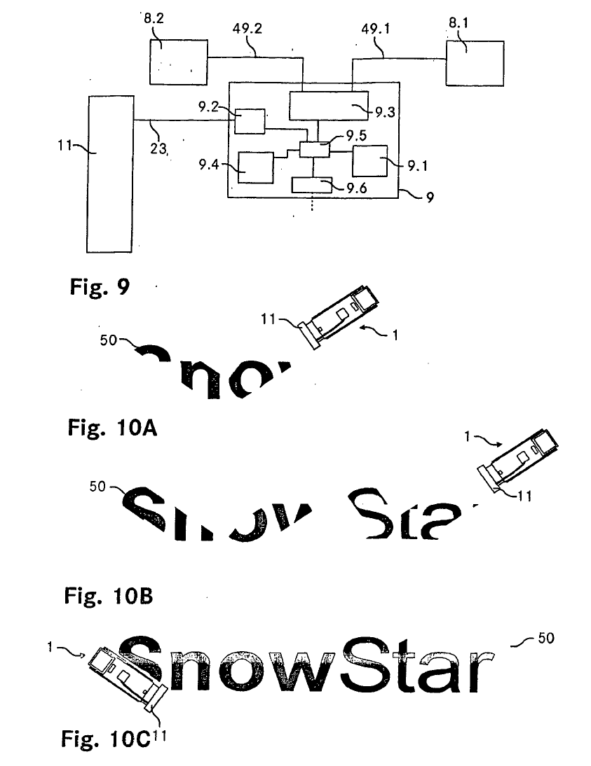

FIG. 9 shows a schematic illustration of the circuit of an apparatus according to the invention. The spraying apparatus 11 is monitored by the controller 9 via the control line 23. The controller 9 comprises a computer, essentially a conventional portable personal computer (Notebook), which has storage means 9.1 for storage of the required data, in particular image data and position details, monitoring means 9.2 for monitoring the spraying apparatus 11, in particular an appropriate appliance driver and processing means 9.3 for processing the position information. This position information is transmitted via data lines 49.1, 49.2 from the two GPS receivers 8.1, 8.2 to the controller 9.

Since both the position of the left-hand GPS receiver 8.1 and the position of the right-hand GPS receiver 8.2 have been defined, it is possible to determine not only the position of the piste groomer, but also its orientation. The area which is currently being covered by the spraying apparatus 11 is thus known precisely at all times.

The controller 9 also has software 9.4 for controlling the overall process. This software runs on a central control unit 9.5 and, in particular, monitors what parts of the image to be sprayed have already been produced. For this purpose, the corresponding position data that has been obtained by the processing means 9.3 is stored in the storage means 9.1. A comparison with the stored previous position data is then carried out in the central control unit 9.5 at each position, and this indicates whether the spraying apparatus 11 must be activated. The central control unit 9.5 also processes the image and position data that is stored in the storage means 9.1 to form control data for the spraying apparatus 11, and this is then transmitted to the monitoring means 9.2.

Finally, the controller 9 also has an interface 9.6, which has means for reception of new image data, position data and new software. Data such as this can be read into the appropriate personal computer drive via a storage medium, for example a floppy disk, CD-ROM or DVD. It is optionally transmitted by the use of cables, for example via a USB interface or the Ethernet, to the controller 9, or means are provided for wire-free reception of data, for example via GSM or Bluetooth.

If a spraying head which can be moved backwards and forwards like an inkjet printer is provided, its movement is controlled in such a way that the entire surface over which the piste groomer is being driven is covered by the spraying apparatus during continuous movement of the piste groomer. For this purpose, the spraying head has a specific spraying depth, which corresponds to the length of one row of nozzles. During the lateral movement of the spraying head in one direction, the nozzles are active and thus produce a slightly inclined, sprayed path because of the forward movement of the piste groomer. The backward movement of the spraying head, during which no spraying takes place, is carried out very quickly, so that the piste groomer travels only a short distance in this time. The next sprayed path then runs parallel to the first path. In order to avoid blank strips occurring between the sprayed paths, the speeds of the spraying head and the speed of the piste groomer are matched to the spraying depth (and to the current width of the sprayed area, which may be smaller than the maximum possible width).

FIGS. 10A-C show a schematic illustration of the method according to the invention. An image is produced in the form of tracks on the snow surface, in the illustrated example the inscription 50 “SnowStar”. In this case, the track width corresponds essentially to the width of the spraying apparatus 11, which is arranged at the rear end of the piste groomer 1. The route which the piste groomer 1 describes on the surface can be chosen as required, because the controller deactivates the spraying apparatus 11 as soon as it passes once again over a section which has already been processed. As soon as the spraying apparatus 11 is driven into a region which has not yet been processed again, it is activated again by the controller. Depending on the condition of the snow and in order to improve the efficiency, it may, of course, nevertheless be advantageous to choose the route such that every area of the surface is passed over as far as possible only once, so that the already sprayed surfaces are retained optimally and are not processed again by the groomer. Particularly in the case of snow surfaces which are restricted at their edge, for example by trees, rocks or steep inclines, a route such as this is, however, often not possible.

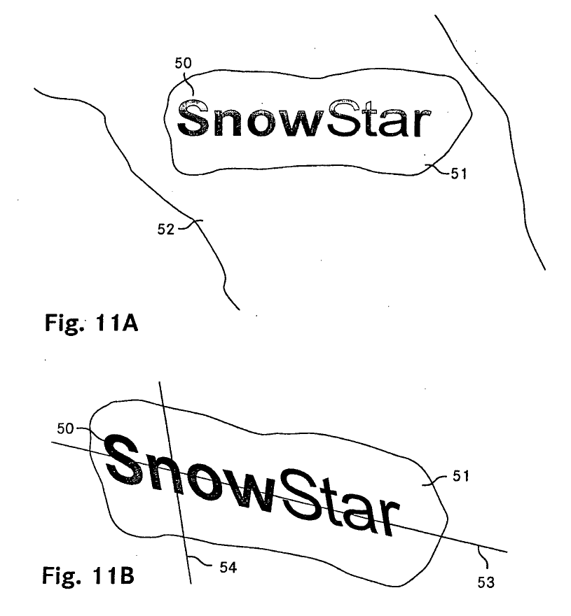

FIG. 11A shows a schematic illustration of an inscription 50, seen from a predetermined observation position, for example a camera location for a sports transmission. The inscription 50 has been sprayed onto a snow surface 51 which is located on a slope 52. The predetermined observation position is located to the left below the snow surface 51 in a direction which includes an angle of about 350 with the normal to the snow surface 51. From this observation position (and from other observation positions along the observation direction), the inscription appears to be vertical and correctly proportioned.

FIG. 11B shows a schematic illustration of the inscription 50 as it is sprayed onto the snow surface 51, seen from a position vertically above the snow surface 51, from the same distance as the observation position in FIG. 11A. The inscription 50 has been distorted for spraying purposes in order for it to offer the desired impression from the predetermined observation position. Its horizontal axis 53 and its vertical axis 54 include an angle, and the inscription has also been stretched along the two axes 53, 54 in order to compensate for the apparent loss of length which results from the oblique observation direction. The image thus appears to be distorted completely, from all incident angles, from the predetermined observation direction.

The apparatus according to the invention, particularly the controller, the color tank and the spraying apparatus, can be integrated in a single unit, which is preferably arranged at the rear end of the load surface of the piste groomer. This makes it easier to fit and to remove the apparatus, as is particularly advantageous when the piste groomer is additionally (or mainly) used for its normal tasks, such as piste processing. In this variant, one of the GPS receivers is advantageously likewise integrated in the unit, while the second can be fitted at a specific distance away from it.

Other variants for the arrangement of the various parts of the apparatus are also possible. For example, the controller can be integrated in the driver's cab, so that it is better protected against weather influences and requires a less costly housing. Optionally and alternatively, the apparatus can be remotely controlled; that is to say the main part of the controller, in particular the central control unit, the software, the interface and the storage means are arranged independently of the piste groomer, for example in a control building, and communicate with the apparatus according to the invention via, for example, radio, GSM or some other wire-free channel.

The piste groomer may also have specific means for preparation of the snow surface for the color to be sprayed on, for example rollers with a specific surface structure, which are arranged in front of the spraying apparatus in the direction of travel. Rollers such as these flatten the snow surface and if required produce a surface structure which is optimally suitable for application of the color or for viewing of the complete image.

Furthermore, the piste groomer may have additional means for subsequent work on the sprayed surface. Means such as these, for example different types of rollers, assist, for example, the process of working the sprayed color into the snow surface, and as it were lead to the sprayed-on color being fixed.

The spraying apparatus may optionally also be arranged at a different point on the piste groomer, for example at the front or at the side. The arrangement behind the groomer is, however, preferable because this means that there is no more need for the vehicle to drive over the colored section of the snow surface which has been processed.

Finally, the spraying apparatus may be designed or controlled differently. Instead of a single spraying head which can be moved along the entire vehicle width, a plurality of movable spraying heads may cover the vehicle width. This allows the vehicle to travel at higher speed for the same spraying head speed. A transversely located row of nozzles, which covers the entire vehicle width, may be provided instead of the movable spraying head. Spraying systems and methods from the field of inkjet printing, or else from airbrush technology, may also be used. The spraying apparatus can also be controlled in such a way that color is emitted during both lateral movements of the spraying head. If the aim is to produce tracks which are precisely at right angles to the direction of travel of the vehicle, the spraying apparatus can be arranged at an angle, matched to the speed of the vehicle. Furthermore, depending on the image to be sprayed, a greater or lesser number of colors may be used, for example for monochrome images or for images with special effects (silver or gold colors, fluorescent colors).

Apparatuses of different design but in principle of similar construction are suitable for attachment to other vehicles, for example to snowmobiles, cars, cross-country vehicles or agricultural vehicles. The apparatus according to the invention can also be attached via a cable to a helicopter winch. In this case, the height above the ground is preferably also measured, in addition to the latitude and longitude coordinates. The amount of color sprayed on and the nozzle settings can be influenced appropriately.

In summary, it can be stated that the invention provides a method and an apparatus for production of an image, which improve the introduction and dissemination of advertising in winter sports regions.

1. A method for producing an image on a land surface by means of an emission apparatus, wherein the emission apparatus is first of all moved to a first point on the surface, after which a circling process is carried out a plurality of times, comprising the following steps:
a) determination of a position of the emission apparatus;
b) emission of a marking substance onto the land surface, as a function of the determined position;
c) movement of the emission apparatus to a further point on the land surface.

2. The method as claimed in claim 1, wherein the circling process furthermore comprises the following steps:
d) storage of the determined position of the emission apparatus,
e) emission of the marking substance as a function of the already stored positions.

3. The method as claimed in claim 1, which furthermore comprises the following steps:
f) determination of an instantaneous speed of the emission apparatus with respect to the land surface;
g) matching of an emission power with which the marking substance is emitted to the instantaneous speed.

4. The method as claimed in one of claim 1, which further comprises the following step:
h) production of the image by distortion of image data as a function of angles between the land surface and a predetermined observation direction.

5. The method as claimed in claim 1, wherein the position is determined by means of a navigation system, in particular GPS or GLONASS, preferably differential GPS (dGPS).

6. The method as claimed in claim 1, wherein the image is produced on a surface composed of snow, wherein color, in particular liquid color and preferably food color, is emitted onto the surface composed of snow.

7. The method as claimed in claim 1, wherein the image is produced on a road surface, with a color which can be removed, in particular an alcohol-based color, being emitted onto the road surface.

8. The method as claimed in claim 7, wherein the color contains reflective constituents.

9. The method as claimed in claim 1, wherein the image is produced on a surface composed of sand, wherein color is emitted onto the surface.

10. The method as claimed in claim 6, wherein the color is emitted by means of at least one nozzle onto the land surface.

11. The method as claimed in claim 6, wherein the color is emitted onto the land surface by means of a printing roller.

12. The method as claimed in claim 1, wherein the image is produced on a fertile surface, wherein the marking substance comprises plant seeds which are sowed onto the fertile surface by the emission apparatus.

13. The method as claimed in claim 1, wherein the emission apparatus is arranged on a vehicle, and wherein the emission apparatus is moved over the land surface with the vehicle.

14. The method as claimed in claim 13, wherein the vehicle is moved over the land surface automatically on the basis of the positions that have been found.

15. An apparatus for production of an image on a land surface, having position-finding means for determination of a position of the apparatus, having emission means for emission of a marking substance onto the land surface, and having control means for automatically controlling the emission means as a function of the determined position.

16. The apparatus as claimed in claim 15, wherein the position-finding means comprise a receiver for a navigation system, in particular GPS or GLONASS, preferably differential GPS (dGPS).

17. The apparatus as claimed in claim 16, wherein the position-finding means comprise at least two receivers, which are arranged at a distance from one another, for the navigation system.

18. The apparatus as claimed in claim 15, wherein the control means comprise storage means for storage of specific positions and means for automatically controlling the emission means as a function of the stored positions.

19. The apparatus as claimed in claim 15, comprising means for determination of an instantaneous speed of the apparatus with respect to the land surface, wherein the control means comprise means for controlling the emission means as a function of the determined instantaneous speed.

20. The apparatus as claimed in claim 15, wherein the control means comprise means for distortion of image data as a function of angles between the land surface and a predetermined observation direction.

21. The apparatus as claimed in claim 15, wherein the emission means comprise a row of nozzles, which are arranged alongside one another and fixed with respect to the apparatus, for spraying color onto the land surface.

22. The apparatus as claimed in claim 21, wherein the emission means are connected by supply lines to tanks for a plurality of primary colors, wherein the emission means comprise a mixing apparatus, which is arranged upstream of the nozzles, for mixing the primary colors as a function of a desired intended color.

23. The apparatus as claimed in claim 21, wherein the emission means for spraying each of a plurality of primary colors comprise a row of nozzles which are arranged fixed alongside one another, with the rows being arranged one behind the other.

24. The apparatus as claimed in claim 15, wherein the apparatus can be fitted to a vehicle, in particular a snowmobile, a road vehicle or a cross-country vehicle, or to an agricultural vehicle, in order to move the apparatus over the land surface.

25. The apparatus as claimed in claim 24, wherein the apparatus can be fitted interchangeably to a piste groomer, with the emission apparatus comprising a printing device with a lateral extent which corresponds at least approximately to the lateral extent of the piste groomer, wherein the printing device can be fitted to an existing rear fitting on the piste groomer.

26. The apparatus as claimed in claim 17, wherein the two receivers for the navigation system are arranged close to the two lateral ends of the printing device.

27. The apparatus as claimed in claim 25, comprising a drive controller which is coupled to the position-finding means and is designed in such a manner that it can control the vehicle automatically, so that the apparatus is moved over the land surface automatically.
